(19) United States
(12) Patent Application Publication
(10) Pub. No.: US 2024/0234026 A9
(43) Pub. Date: Jul. 11, 2024

(54) Passive Negative Inductor and a Method for Fabricating the Passive Negative Inductor

(71) Applicant: Mitsubishi Electric Research Laboratories, Inc., Cambridge, MA (US)

(72) Inventors: Koon Hoo Teo, Cambridge, MA (US); Nadim Chowdhury, Cambridge, MA (US)

(21) Appl. No.: 18/048,680

(22) Filed: Oct. 21, 2022

(51) Int. Cl. H01F 38/02; H01F 7/06; H01F 17/04

(52) U.S. Cl. CPC H01F 38/023; H01F 7/06; H01F 17/04

(57) ABSTRACT

The present disclosure discloses a negative inductor device. The negative inductor device comprises a negative inductor comprising a ferromagnetic material and a conductive material arranged inside the ferromagnetic material. The negative inductor device further comprises a current limiting circuit electrically coupled to the negative inductor and configured to supply an electric current of magnitude within a range, the range being defined by a first local minimum and a second local minimum of a current-energy curve of the ferromagnetic material.

### TECHNICAL FIELD

The present disclosure relates generally to electrical circuits, and more particularly to a negative inductor and a method for fabricating the negative inductor.

### BACKGROUND

An inductor is commonly a passive two-terminal electrical component that stores energy in form a magnetic field when electric current flows through it. An exemplar implementation of a basic inductor is an insulated wire wound into a coil. When the current flowing through the coil changes, time-varying magnetic field induces an electromotive force (e.m.f.) (voltage) in the coil, as described by Faraday's law of induction. Such an inductor is also referred to herein as a positive inductor to contrast this inductor with a negative inductor.

The negative inductor, at least in theory, exhibits properties opposite to properties of the positive inductor. For example, in the positive inductor, magnetic flux associated with the positive inductor increases with increase of a current through the positive inductor. However, in the negative inductor, this phenomenon is reversed, i.e., magnetic flux associated with the negative inductor decreases with increase of a current through the negative inductor. Similarly, the positive inductor has a “U” shaped Energy vs Current curve (U vs i), which gives a value of inductance. In contrast, a shape of Energy vs Current curve of the negative inductor is an inverted “U.”

An effect of the negative inductors is evaluated based on a theory supported by active negative inductors such as a negative impedance converter (NIC). NIC is an active circuit that injects energy into circuits in contrast to an ordinary load that consumes energy from them. NIC is achieved by adding or subtracting excessive varying voltage in series to a voltage drop across an equivalent positive impedance. However, having an active negative inductor in the circuits takes extra energy and extra space, which is not desirable.

Accordingly, there is still a need for the negative inductor.

### SUMMARY

It is an object of some embodiments to provide a component of compound material that can be used as a negative inductor. It is also an object of some embodiments of to fabricate a negative inductor using passive elements, to yield a passive negative inductor. Additionally or alternatively, it is an object of some embodiments to provide such a negative inductor that is suitable to be included in an integrated circuit. Additionally or alternatively, it is an object of some embodiments to provide a method for fabricating the negative inductor.

Some embodiments are based on an understanding that properties of a ferromagnetic material can be employed to construct the negative capacitor. To that end, some embodiments aim to explore the properties of the ferromagnetic materials to construct the negative inductor. For example, some embodiments are based on recognition that a current-energy curve of the ferromagnetic material is a ‘W’ shaped curve. The current-energy curve of the ferromagnetic material includes two local minima, namely, a first local minimum and a second local minimum. In between the two local minima, at the proximity of zero current, there exists an inverted U shape which is similar to a current-energy curve of the negative inductor. Thus, the inverted U shape of the current-energy curve of the ferromagnetic material has negative curvature which results in negative inductance. A zone corresponding to the inverted U shape of the current-energy curve of the ferromagnetic material is referred to as a negative inductance zone.

Some embodiments are based on the recognition that, as the negative inductance zone has high energy, the ferromagnetic material doesn't stay in the negative inductance zone and ends up being in either of the two local minima. Moreover, the ferromagnetic material is not conductive, which prohibits implementation of inductors.

Some embodiments are based on a realization supported by a simulation and experimentation that if a conductive material is inserted into the ferromagnetic material to pass current, magnetic field of the conductive material passing current interacts with the ferromagnetic material to yield the negative inductor properties within the negative inductance zone. Such an interaction allows the creation of an electric component acting as the negative inductor. To that end, the negative inductor may be constructed by arranging the conductive material inside the ferromagnetic material.

In an embodiment, the conductive material is arranged inside the ferromagnetic material such that a majority of portion of the conductive material is within the ferromagnetic material and two opposite ends of the conductive material protrude to surface or to outside of the ferromagnetic material. The two ends of the conductive material form terminals of the negative inductor for electrical connections with other devices or circuits. In an alternate embodiment, the conductive material arranged inside the ferromagnetic material such that the entirety of the conductive material is completely surrounded by the ferromagnetic material. In such an embodiment, to enable the electrical connections, the terminals are formed separately from a material different from the conductive material and are electrically connected to the opposite ends of the conductive material.

Further, some embodiments are based on the realization that, to operate in the negative inductance zone, the negative inductor has to be supplied with an electric current of magnitude that lies within a range defined by the first local minimum and the second local minimum, of the current-energy curve of the ferromagnetic material. To supply the electric current of magnitude within the range defined by the first local minimum and the second local minimum, of the current-energy curve of the ferromagnetic material, the negative inductor is connected with a current limiting circuit. The negative inductor together with the current limiting circuit forms a negative inductor device.

The current limiting circuit is configured to supply an electric current ‘i’ of magnitude within the range defined by the first local minimum and the second local minimum, of the current-energy curve of the ferromagnetic material. For example, a current ‘i₁’ corresponding to the first local minimum and a current ‘i₂’ corresponding to the second local minimum define a range of magnitude of current (i₁ to i₂). The current limiting circuit supplies the electric current ‘i’ of magnitude that lies within the range (i₁ to i₂).

According to an embodiment, a range of the negative inductance zone depends on a type of the ferromagnetic material, and/or mutual arrangement of the conductive material within the ferromagnetic material. For example, in some embodiments, the ferromagnetic material is in shape of a slab and the conductive material is a wire twisted into a spiral. A cross-section of the wire includes one or a combination of a circular, a semi-circular, a rectangular, and a semi-rectangular shape. The slab shaped ferromagnetic material encloses the spiral shaped conductive material such that a geometrical center of the slab shaped ferromagnetic material coincides with a geometrical center of the spiral shaped conductive material. Such shapes and arrangement of the ferromagnetic material and the conductive material is advantageous, for example, inductance of the negative inductor is increased by using the spiral shaped conductive material. Since the negative inductor is constructed using passive elements, such as, the ferromagnetic material and the conductive material, the negative inductor is referred to as a passive negative inductor.

In some embodiments, types of the ferromagnetic material and the conductive material are selected mutually or independently based on applications of the negative inductor. Examples of the conductive material used by different embodiments include copper, aluminum, steel, iron and the like. Examples of the ferromagnetic material used by different embodiments include various ferromagnetic oxides, cobalt, magnetite, dysprosium, nickel, gadolinium, awaruite, permalloy, and the like.

Some embodiments are based on the realization that it is advantageous to connect the negative inductor in parallel or in series with the positive inductor. For example, the negative inductor may be connected in parallel with the positive inductor for inductor amplification. Additionally, the negative inductor may be used in different circuits, for example, microwave circuits, Monolithic Microwave Integrated Circuits (MMIC), Radio Frequency Integrated Circuits (RFIC), power electronic circuits, and the like. For instance, in RFIC, realization of an inductor consumes a significant chip area. Therefore, it is desirable to fabricate an inductor that consumes less chip area. According to an embodiment, the negative inductor can be used to amplify value of a positive inductor in the RFIC, by consuming less chip area. Additionally, in some embodiments, the negative inductor can be used as a non-Foster element in a variety of devices and components such as non-Foster wideband antennas, non-Foster artificial magnetic conductors, to eliminate narrowband resonant behavior inherent to the aforesaid devices.

Additionally, some embodiments provide a method for fabrication of the negative inductor. The method includes providing a substrate. The substrate includes, but is not limited to, silicon (Si), silicon carbide (SiC), diamond, gallium nitride (GaN) and so on. For the purpose of explanation, a Si-substrate is considered. The Si-substrate may be cleaned according to piranha cleaning method and/or Radio Corporation of America (RCA) clean. Further, ferromagnetic oxide is deposited on the cleaned Si-substrate using a deposition method, for example, a pulsed laser deposition method.

After the ferromagnetic oxide deposition, sample may be annealed in an oxygen environment. Further, a metal spiral is formed on a surface of the ferromagnetic oxide using, for example, photolithography and lift off process. Furthermore, another layer of the ferromagnetic oxide is deposited to completely submerge the metal spiral into the ferromagnetic oxide. Another layer of the ferromagnetic oxide is deposited using the pulsed laser deposition method.

Accordingly, one embodiment discloses a negative inductor device. The negative inductor device comprises a negative inductor comprising a ferromagnetic material and a conductive material arranged inside the ferromagnetic material. The negative inductor device further comprises a current limiting circuit electrically coupled to the negative inductor and configured to supply an electric current of magnitude within a range defined by a first local minimum and a second local minimum of a current-energy curve of the ferromagnetic material.

Accordingly, another embodiment discloses a negative inductor. The negative inductor device comprises a ferromagnetic material; and a conductive material partly enclosing the ferromagnetic material such that opposite ends of the conductive material are protruded from the ferromagnetic material, wherein the opposite ends of the conductive material that are protruded from the ferromagnetic material correspond to terminals of the negative inductor.

Accordingly, yet another embodiment discloses a method for fabrication of a negative inductor. The method comprises depositing a first layer of ferromagnetic material on the substrate; forming a metal spiral on a surface of the first layer of ferromagnetic material; and depositing a second layer of ferromagnetic material on the first layer of ferromagnetic material and the metal spiral.

### BRIEF DESCRIPTION OF THE DRAWINGS

FIG. 1A shows a schematic depicting current-flux characteristics of a negative inductor, according to some embodiments of the present disclosure.

FIG. 1B shows a schematic depicting current-energy characteristics of the negative inductor, according to some embodiments of the present disclosure.

FIG. 1C shows an energy landscape of a ferromagnetic material, according to some embodiments of the present disclosure.

FIG. 2 illustrates a negative inductor, according to some embodiments of the present disclosure.

FIG. 3A shows a schematic of a negative inductor device, according to some embodiments of the present disclosure.

FIG. 3B illustrates a range of magnitude of current defined by a first local minimum and a second local minimum of a current-energy curve of the ferromagnetic material, according to some embodiments of the present disclosure.

FIG. 3C shows a diagram of an electric circuit for implementation of a current limiting circuit, according to some embodiments of the present disclosure.

FIG. 4A shows a schematic of a negative inductor, according to some other embodiments of the present disclosure.

FIG. 4B shows a different perspective view of the negative inductor of FIG. 4A, according to some other embodiments of the present disclosure.

FIG. 5A shows a diagram of an electric circuit including the negative inductor and a positive inductor connected in parallel, according to some other embodiments of the present disclosure.

FIG. 5B shows a diagram of an electric circuit including the negative inductor and the positive inductor connected in series, according to some other embodiments of the present disclosure.

FIG. 6 shows a schematic of a method for fabrication of the negative inductor, according to some other embodiments of the present disclosure.

The presently disclosed embodiments will be further explained with reference to the attached drawings. The drawings shown are not necessarily to scale, with emphasis instead generally being placed upon illustrating the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

It is an object of some embodiments to provide a component of compound material that can be used as a negative inductor. Additionally, it is an object of some embodiments to fabricate a negative inductor using passive elements, to yield a passive negative inductor. Additionally or alternatively, it is an object of some embodiment to provide such a negative inductor that is suitable to be included in an integrated circuit.

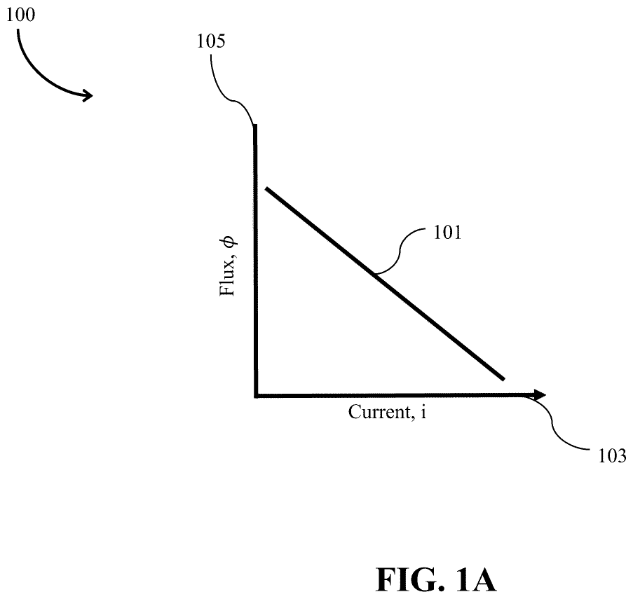

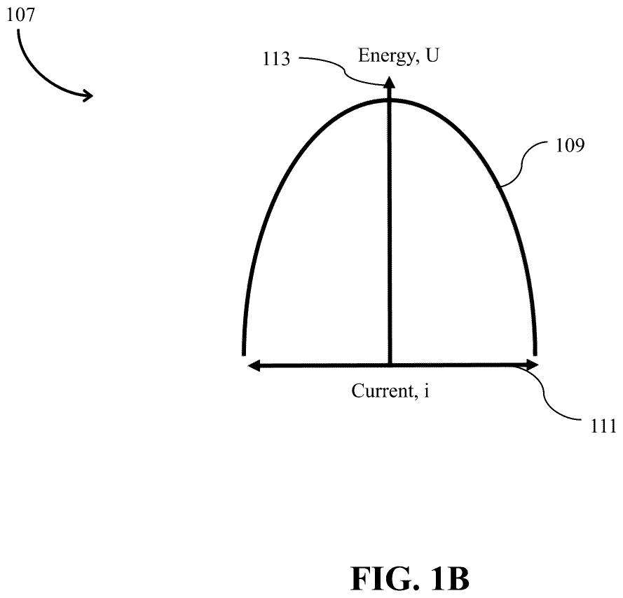

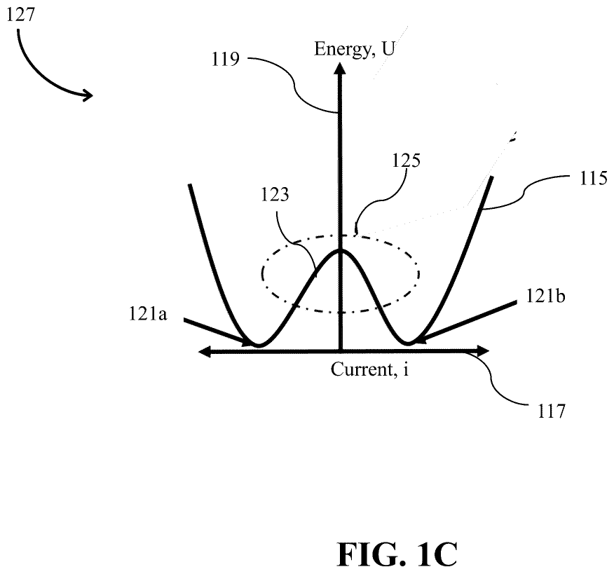

The negative inductor exhibits properties opposite to properties of a positive inductor (or a normal inductor). For example, in the positive inductor, magnetic flux associated with the positive inductor increases with increase of current through the positive inductor. However, in the negative inductor, this phenomenon is reversed, as described below in FIG. 1A.

FIG. 1A shows a schematic 100 depicting current-flux characteristics of the negative inductor, according to some embodiments of the present disclosure. A current-flux curve 101 is plotted between a current 103 through the negative inductor and magnetic flux 105 associated with the negative inductor. The current-flux curve 101 implies that the magnetic flux associated with the negative inductor decreases with increase of the current through the negative inductor.

Additionally, some embodiments are based on understanding that a current-energy curve of the positive inductor is a U shaped curve, whereas a current-energy curve of the negative inductor is an inverted U shaped curve.

FIG. 1B shows a schematic 107 depicting current-energy characteristics (or a current-energy curve) of the negative inductor, according to some embodiments of the present disclosure. A current-energy curve 109 of the negative inductor is plotted between a current 111 through the negative inductor and an energy 113 of the negative inductor. The shape of the current-energy curve 109 of the negative inductor is inverted U.

Some embodiments are based on understanding that properties of a ferromagnetic material can be employed to construct the negative capacitor that exhibits properties described above in FIG. 1A and FIG. 1B. To that end, some embodiments aim to explore the properties of the ferromagnetic materials to construct the negative inductor.

FIG. 1C shows an energy landscape 127 of the ferromagnetic material, according to some embodiments of the present disclosure. A current-energy curve 115 of the ferromagnetic material is plotted between a current 117 through the ferromagnetic material and an energy 119 of the ferromagnetic material. The current-energy curve 115 includes two local minima, namely, a first local minimum 121a and a second local minimum 121b. In between the two local minima 121a and 121b, at the proximity of zero current, there exists an inverted U shape 123 which is similar to the current-energy curve 109 of the negative inductor. Thus, the inverted U shape 123 of the current-energy curve 115 of the ferromagnetic material has negative curvature which results negative inductance. A zone 125 corresponding to the inverted U shape 123 of the current-energy curve 115 is referred to as a negative inductance zone.

According to an embodiment, the negative inductance behavior can be understood from Landau mean field theory. According to Landau mean field theory, Gibbs free energy of the ferromagnetic material is given by the following equation

$${U}_{G i b b s} = - M \times B + \frac{a}{2} {M}^{2} + \frac{c}{4} {M}^{4}$$

Here, a and c are material based parameters. As long as temperature is less than curie temperature (which is typically >10000 deg. C), the material based parameter ‘a’ is negative giving rise to the negative inductance.

Some embodiments are based on the recognition that, as the negative inductance zone 125 has high energy, the ferromagnetic material doesn't stay in the negative inductance zone 125 and ends up being either of the two local minima 121a and 121b. Moreover, the ferromagnetic material is not conductive, which prohibits implementation of inductors.

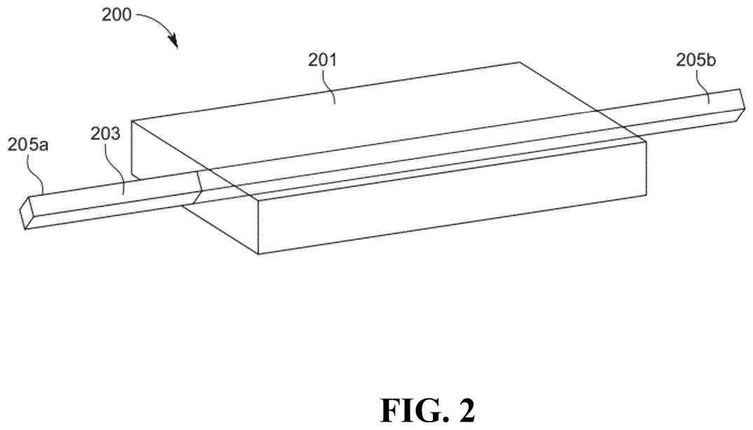

Some embodiments are based on a realization supported by a simulation and experimentation that if a conductive material is inserted into the ferromagnetic material to pass current, magnetic field of the conductive material passing current interacts with the ferromagnetic material to yield the negative inductor properties within the negative inductance zone 125. Such an interaction allows the creation of an electric component acting as the negative inductor. To that end, the negative inductor may be constructed by arranging the conductive material inside the ferromagnetic material. Such a negative inductor is described in FIG. 2.

FIG. 2 illustrates a negative inductor 200, according to some embodiments of the present disclosure. The negative inductor 200 includes a ferromagnetic material 201 and a conductive material 203 arranged inside the ferromagnetic material 201. In an embodiment, the conductive material 203 is partly enclosed inside the ferromagnetic material 201 such that a majority of portion of the conductive material 203 is within the ferromagnetic material 201 and two opposite ends: a first end 205a and a second end 205b of the conductive material 203 protrude to surface or to outside of the ferromagnetic material 201. The first end 205a and the second end 205b of the conductive material 203 form terminals of the negative inductor 200 for electrical connections with other devices or circuits. Thus, the first end 205a and the second end 205b are referred to as a first terminal 205a and a second terminal 205b, respectively.

In an alternate embodiment, the conductive material 203 arranged inside the ferromagnetic material 201 such that the entirety of the conductive material 203 is completely surrounded by the ferromagnetic material 203. In such an embodiment, to enable the electrical connections, the first terminal 205a and the second terminal 205b are formed separately from a material different from the conductive material 203 and are electrically connected to opposite ends of the conductive material 203, respectively.

Further, some embodiments are based on the realization that, to operate in the negative inductance zone 125, the negative inductor 200 has to be supplied with an electric current of magnitude that lies within a range defined by the first local minimum 121a and the second local minimum 121b. To supply the electric current of magnitude within the range defined by the first local minimum 121a and the second local minimum 121b, the negative inductor 200 is connected with a current limiting circuit 301. The negative inductor 200 together with the current limiting circuit 301 forms a negative inductor device.

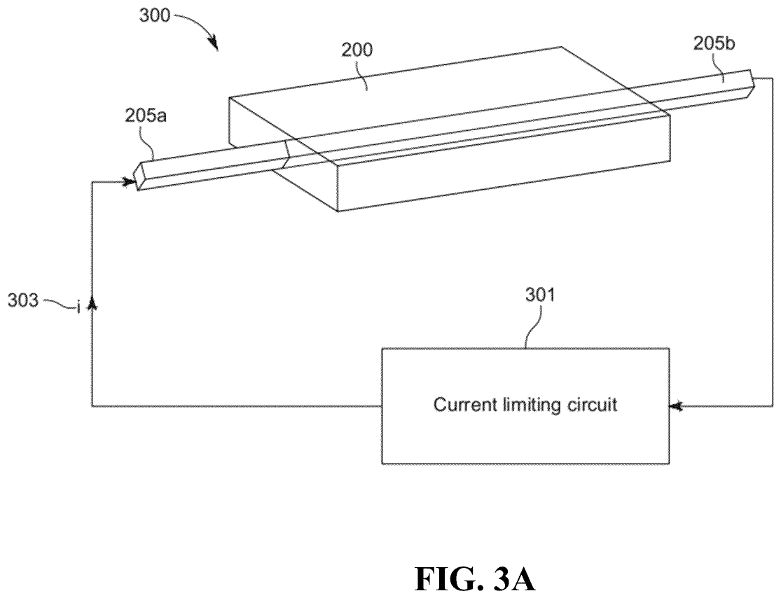

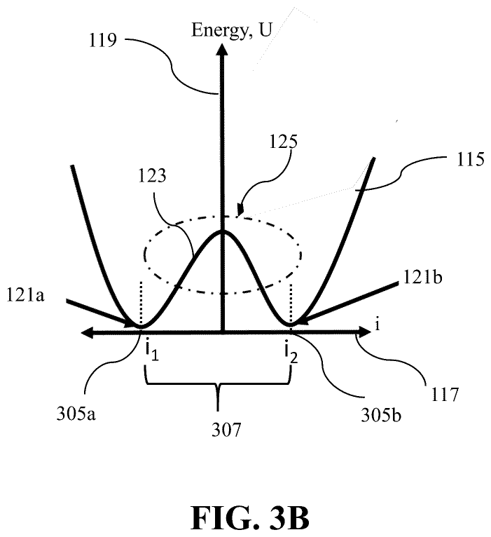

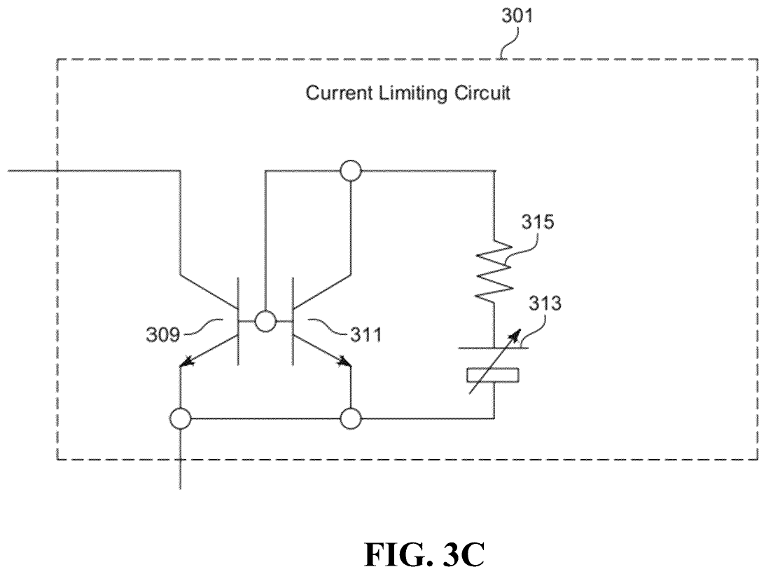

FIG. 3A shows a schematic of a negative inductor device 300, according to some embodiments of the present disclosure. The negative inductor device 300 includes the negative inductor 200 and the current limiting circuit 301. The negative inductor 200 is electrically coupled to the current limiting circuit 301. For example, the current limiting circuit 301 is connected to the negative inductor 200 via the first terminal 205a and the second terminal 205b. The current limiting circuit 301 is configured to supply an electric current ‘i’ 303 of magnitude within the range defined by the first local minimum 121a and the second local minimum 121b.

For example, referring to FIG. 3B, a current ‘i₁’ 305a corresponding to the first local minimum 121a and a current ‘i₂’ 305b corresponding to the second local minimum 121b define a range of magnitude of current (i₁ to i₂) 307. The current limiting circuit 301 supplies the electric current ‘i’ 303 of magnitude that lies within the range 307. An example implementation of the current limiting circuit 301 is described below in FIG. 3C.

FIG. 3C shows a diagram of an electric circuit for implementation of the current limiting circuit 301, according to some embodiments of the present disclosure.

The current limiting circuit 301 includes bipolar transistors 309 and 311, a reference source 313, and a resistor 315. The bipolar transistors 309 and 311 constitute a current mirror circuit. According to an embodiment, the reference source 313 outputs a reference value that defines a magnitude of the current which flows through the bipolar transistor 311 and the negative inductor 200. The reference source 313 outputs the reference value based on the range 307. The reference source 313 may output the reference value as a fixed value, or may output a variable reference value that defines a magnitude of the current within the range 307. Further, current which flows through bipolar transistor 309 is based on the current that passes though the bipolar transistor 311.

The circuit configuration of the current limiting circuit 301 illustrated in FIG. 3C is merely by way of example and the current limiting circuit 301 of the present disclosure is not limited to the circuit configuration illustrated in FIG. 3C. The current limiting circuit 301 may be of different circuit configurations.

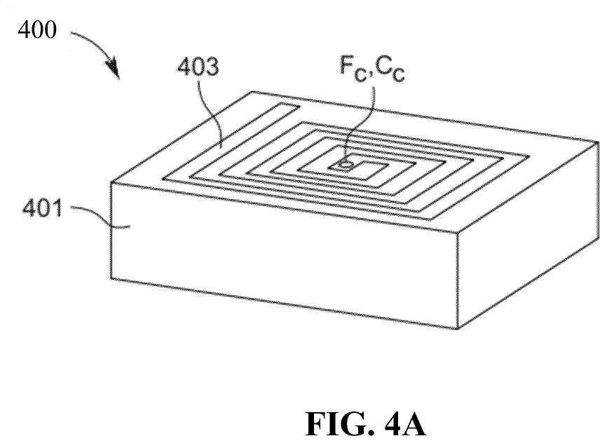

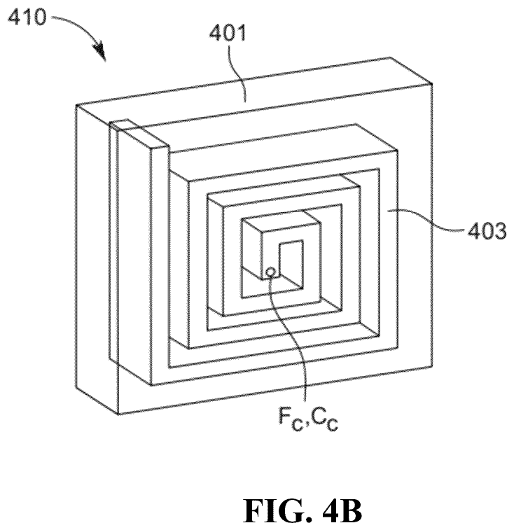

According to an embodiment, a range of the negative inductance zone 125 depends on a type of the ferromagnetic material 201, and/or mutual arrangement of the conductive material 203 within the ferromagnetic material 201. For example, in some embodiments, the ferromagnetic material 201 has a first shape, the conductive material 203 has a second shape, and the first shape of the ferromagnetic material encloses the second shape of the conductive material such that a geometrical center of the first shape coincides with a geometrical center of the second shape. The first shape and the second shape are symmetrical or unsymmetrical shapes. Such an embodiment is described below in FIGS. 4A and 4B.

FIG. 4A shows a schematic of a negative inductor 400, according to some other embodiments of the present disclosure. FIG. 4B shows a different perspective view 410 of the negative inductor 400, according to some other embodiments of the present disclosure. The negative inductor 400 includes a ferromagnetic material 401 and a conductive material 403. The ferromagnetic material 401 is in shape of a slab and the conductive material 403 is a wire twisted into a spiral. A cross-section of the wire includes one or a combination of a circular, a semi-circular, a rectangular, and a semi-rectangular shape. The slab shaped ferromagnetic material 401 encloses the spiral shaped conductive material 403 such that a geometrical center F. of the slab shaped ferromagnetic material 401 coincides with a geometrical center Cc of the spiral shaped conductive material 403. Such shapes and arrangement of the ferromagnetic material 401 and the conductive material 403 is advantageous, for example, inductance of the negative inductor 400 is increased by using the spiral shaped conductive material 403.

The negative inductor 400 (or the negative inductor 200) is constructed using passive elements, such as, the ferromagnetic material 401 and the conductive material 403. Therefore, the negative inductor 400 (or the negative inductor 200) is referred to as a passive negative inductor.

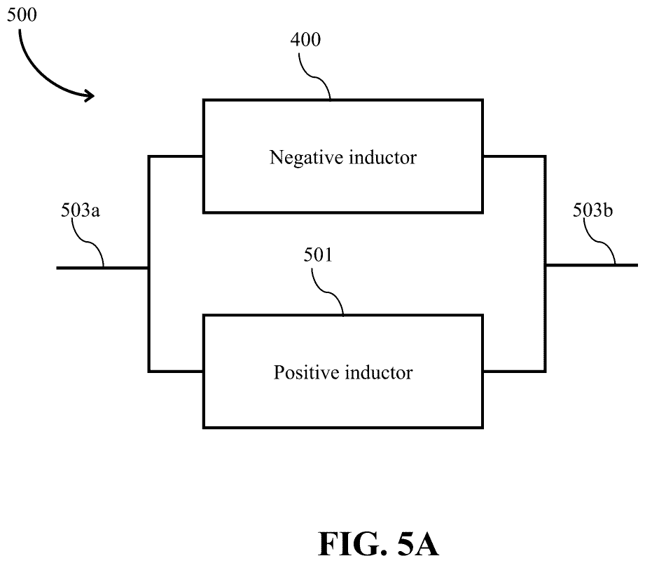

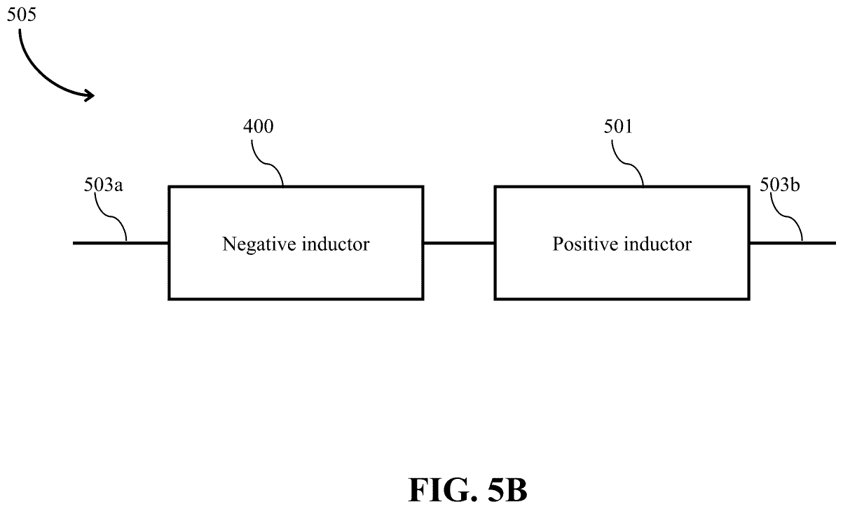

Some embodiments are based on the recognition that it is advantageous to connect the negative inductor 400 in parallel or in series with the positive inductor. For example, the negative inductor 400 may be connected in parallel with the positive inductor for inductor amplification, as described below in FIG. 5A.

FIG. 5A shows a diagram 500 of an electric circuit including the negative inductor 400 and a positive inductor 501 connected in parallel, according to some other embodiments of the present disclosure. Some embodiments are based on understanding that when two positive inductors of inductances L1 and L2 are connected in parallel with each other, then an overall inductance L is less than inductances of the individual inductors.

L=L1∥L2=L1*L2/(L1+L2),here L<L1,L2.

However, if the negative inductor 400 is connected in parallel with the positive inductor 501, then an overall inductance of the parallel connection is larger than the individual inductance. For example, if L2 is negative then L=(L1*−L2)/(L1−L2). Here, L will be positive if and only if |L2|>L1. In such a manner, the negative inductor 400 is used for the inductor amplification. A first terminal 503a and a second terminal 503b are used for enabling electrical connections with other circuits and devices.

Additionally or alternatively, in some embodiments, the negative inductor 400 and the positive inductor 501 may be connected in series. FIG. 5B shows a diagram 505 of an electric circuit including the negative inductor 400 and the positive inductor 501 connected in series, according to some other embodiments of the present disclosure. The series connection of the negative inductor 400 and the positive inductor 501 is advantageous because such a series connection results inductance with higher magnitude with less chip area. Inductors with high magnitudes are required for various analog and Radio Frequency (RF) applications such as oscillator and power amplifier. The series connection of the negative inductor 400 and the positive inductor 501 not only saves the chip area but also can yield inductances with high Q value.

Additionally, the negative inductor 400 may be used in different circuits, for example, microwave circuits, Monolithic Microwave Integrated Circuits (MMIC), Radio Frequency Integrated Circuits (RFIC), power electronic circuits, and the like. For instance, in RFIC, realization of an inductor consumes a significant chip area. Therefore, it is desirable to fabricate an inductor that consumes less chip area. According to an embodiment, the negative inductor 400 can be used to amplify value of a positive inductor in the RFIC, by consuming less chip area.

Additionally, in some embodiments, the negative inductor 400 can be used as a non-foster element in a variety of devices and components such as wideband antennas, and artificial magnetic conductors. The non-foster circuit elements are those that do not obey Foster's theorem. The negative inductor 400 can be used as the non-foster element in the wideband antennas to eliminate narrowband resonant behavior inherent to the wideband antennas.

Additionally, the negative inductor 400 can be used for improving impedance matching between a Power Amplifier (PA) and an antenna. For instance, in a transmitter system, a passive matching network is inserted between an output of Power Amplifier (PA) and the antenna to match an output impedance of the PA to that of the antenna. The passive matching networks typically include one or more capacitors and one or more inductors. The passive matching networks receive power only from their source (typically the PA) and do not need any external source of power. The passive matching networks comply with Foster's Reactance Theorem and work well in matching the impedance of the PA to the impedance the antenna at a single frequency. But they are not perfect, even at a single frequency, since inductors and capacitors in the real world are non-ideal, that is, they have resistance in addition to reactance. Moreover, most practical applications require a transmitter to operate over a bandwidth and especially when physically small size antennas are utilized. It is often not possible to achieve an acceptable or desirable impedance match over an acceptable or desirable bandwidth using Foster (passive) networks. The impedance matching can be improved by using non-foster (or active) network that is based on the negative inductor 400. The non-foster network based on the negative inductor 400 may be referred to a non-Foster impedance matching circuit. The non-foster network based on the negative inductor 400 cancels reactance of the antenna, which in turn improves efficiency and bandwidth of the PA.

Additionally, in some embodiments, the negative inductor 400 can be used as a non-foster element in the artificial magnetic conductors. An Artificial Magnetic Conductor (AMC) is a type of metamaterial that emulates a magnetic conductor over a limited bandwidth. An AMC ground plane enables conformal antennas with currents flowing parallel to a surface because parallel image currents in the AMC ground plane enhance their sources. AMCs may have limited bandwidth. Their bandwidth is proportional to substrate thickness and permeability. At VHF-UHF frequencies, the thickness and/or permeability necessary for a reasonable AMC bandwidth is excessively large for antenna ground-plane applications.

The bandwidth limitation of AMC may be overcome by using the negative inductor 400 as the non-foster element. When AMC is loaded with the negative inductor 400, its negative inductance in parallel with the substrate inductance results in a larger net inductance and hence, a larger AMC bandwidth. Further, the negative inductor 400 may be used as the non-foster element in AMC to eliminate narrowband resonant behavior inherent to AMC.

In some embodiments, types of the ferromagnetic material 401 and the conductive material 403 are selected mutually or independently based on applications of the negative inductor 400. Examples of the conductive material used by different embodiments include copper, aluminum, steel, iron and the like. Examples of the ferromagnetic material used by different embodiments include various ferromagnetic oxides, cobalt, magnetite, dysprosium, nickel, gadolinium, awaruite, permalloy, and the like.

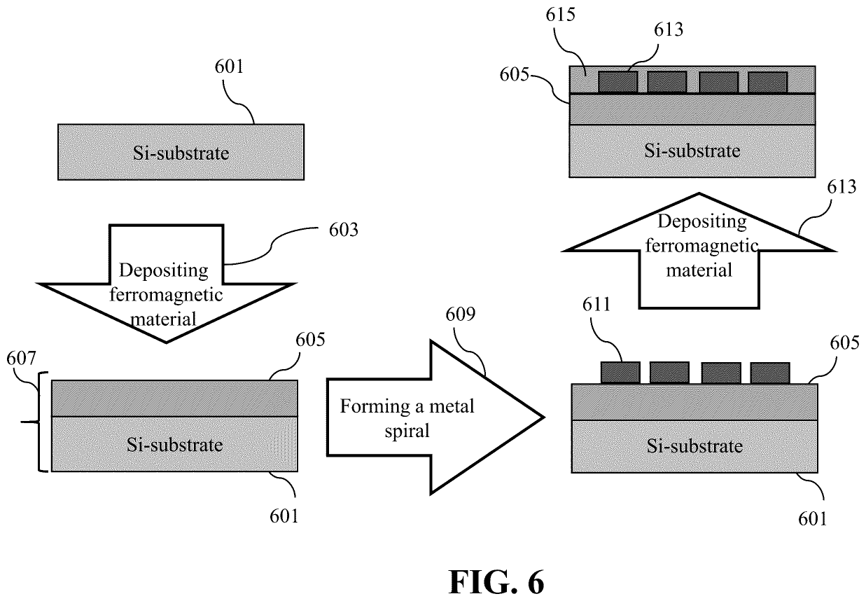

In an embodiment, the negative inductor 400 is formed by dipping the spiral shaped conducting material 403 into ferromagnetic oxide which is a ferromagnetic material. Likewise, the negative inductor 200 is formed by dipping the conducting material 203 into the ferromagnetic oxide. A method for fabrication of the negative inductor 400 (or the negative inductor 200) is explained in detail in FIG. 6.

FIG. 6 shows a schematic of a method for fabrication of the negative inductor 400, according to some other embodiments of the present disclosure. The method includes providing a substrate. The substrate includes, but not limited to, silicon (Si), silicon carbide (SiC), diamond, gallium nitride (GaN) and so on. For the purpose of explanation, a Si-substrate 601 is considered. The Si-substrate 601 may be cleaned according to piranha cleaning method and/or Radio Corporation of America (RCA) clean.

Further, the method includes depositing 603 a first layer 605 of ferromagnetic material (e.g., ferromagnetic oxide) on the cleaned Si-substrate 601 using a deposition method, for example, a pulsed laser deposition (PLD) method. Alternatively, in some implementations, MBE (Molecular Beam Epitaxy), MOCVD (Metal Organic Chemical Vapor Deposition), CVD (Chemical Vapor Deposition), Sputtering, or Electron-Beam Evaporation, may be used for depositing the first layer 605 of the ferromagnetic material. After the ferromagnetic material deposition, sample 607 may be annealed in an oxygen environment.

Further, the method includes forming 609 a metal spiral 611 on a surface of the first layer 605 of ferromagnetic material using, for example, photolithography and/or lift off process. Photolithography involves use of light to produce minutely patterned thin films of suitable materials over the substrate.

Furthermore, the method includes depositing 613 a second layer 615 of the ferromagnetic material on the first layer 605 and the metal spiral 611 to completely submerge the metal spiral 611 into the ferromagnetic material. The second layer 615 of the ferromagnetic material is deposited 613 using the PLD method.

The PLD method is a physical vapor deposition method that allows non equilibrium and versatile growth of complex stoichiometries. PLD combines characteristics of both evaporation and sputtering. Thin film deposition may be achieved by using the PLD method. The thin film deposition is achieved by focusing laser pulses on a target of desired stoichiometry and generating a plume containing atomic species of the target material that deposits on the substrate. For instance, in the PLD, the laser pulses are guided by and focused by high quality quartz optical components that allow energy densities in the range of 2-3 J/cm² on the target. The target spot hit by the laser pulse heats up rapidly and vaporizes, and the vapor absorbs more energy from the laser pulse to break down into a dense plasma. The dense plasma absorbs any remaining energy from the laser pulse and expands to create a plume perpendicular from the target surface resulting in deposition on the substrate placed above directly above the target. The substrate may be rotated during deposition to ensure uniformity and low roughness for film surfaces, and the target is rotated and rastered during laser ablation and deposition in order to ensure uniform ablation of the target.

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

1. A negative inductor device, comprising:
a negative inductor comprising a ferromagnetic material and a conductive material arranged inside the ferromagnetic material; and
a current limiting circuit electrically coupled to the negative inductor and configured to supply an electric current of magnitude within a range, the range defined by a first local minimum and a second local minimum of a current-energy curve of the ferromagnetic material.

2. The negative inductor device of claim 1, further comprising:
a first terminal and a second terminal electrically connected to a first end and a second end of the conductive material, respectively.

3. The negative inductor device of claim 1, wherein the ferromagnetic material has a first shape, the conductive material has a second shape, and the first shape of the ferromagnetic material encloses the second shape of the conductive material such that a geometrical center of the first shape coincides with a geometrical center of the second shape.

4. The negative inductor device of claim 3, wherein each of the first shape and the second shape are symmetrical shapes.

5. The negative inductor device of claim 4, wherein the first shape is a slab and the second shape is a spiral.

6. The negative inductor device of claim 5, wherein a cross-section of the wire includes one or a combination of a circular, a semi-circular, a rectangular, and a semi-rectangular shape.

7. A negative inductor, comprising:
a ferromagnetic material; and
a conductive material partly enclosed in the ferromagnetic material such that opposite ends of the conductive material are protruded from the ferromagnetic material, wherein the opposite ends of the conductive material that are protruded from the ferromagnetic material correspond to terminals of the negative inductor.

8. A negative inductor, comprising:
a ferromagnetic material; and
a conductive material arranged inside the ferromagnetic material.

9. An electric circuit including a positive inductor electrically connected in parallel with the negative inductor of claim 8.

10. An electric circuit including a positive inductor electrically connected in series with the negative inductor of claim 8.

11. A non-foster impedance matching circuit including the negative inductor of claim 8 for impedance matching between a Power Amplifier (PA) and an antenna.

12. An artificial magnetic conductor including the negative inductor of claim 8, the negative inductor of claim 8 acts as a non-foster element.

13. A fabrication method for a negative inductor, the fabrication method comprising:
depositing a first layer of a ferromagnetic material on a substrate;
forming a metal spiral on a surface of the first layer of the ferromagnetic material; and
depositing a second layer of the ferromagnetic material on the first layer of ferromagnetic material, and the metal spiral.

14. The fabrication method of claim 13, wherein the first layer of the ferromagnetic material and the second layer of the ferromagnetic material are deposited using a pulsed laser deposition (PLD).

15. The fabrication method of claim 13, wherein the metal spiral is formed on the surface of the first layer of the ferromagnetic material, using photolithography.
